(19) United States
(12) Patent Application Publication
(10) Pub. No.: US 2005/0234817 A1
(43) Pub. Date: Oct. 20, 2005

(54) Methods and systems for private label transaction processing

(75) Inventors: Steven L. VanFleet, Southport, CT (US); John J. Mascavage, San Mateo, CA (US); Matthew T. Byrne, Papillion, NE (US); Diane Wing, East Lansing, MI (US); Cassandra J. Mollett, Scottsdale, AZ (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Englewood, CO (US)

(21) Appl. No.: 10/825,960

(22) Filed: Apr. 16, 2004

(51) Int. Cl. G06F 17/60

(52) U.S. Cl. 705/40; 705/44; 705/42

(57) ABSTRACT

In one embodiment, a first information packet is received at a payment network from a merchant, which includes a financial transaction cost and a private label card account identifier presented by the customer as a payment for the financial transaction. The private label card is a form of payment accepted only by the merchant or a merchant consortium that includes the merchant. The payment network uses the private label card account identifier to determine a financial account maintained by the customer at a financial institution and authorization information that allows debit access to the identified financial account. The payment network generates a second information packet comprising the transaction information, the account information, and the authorization information. The second information is transmitted from the payment network to the financial institution with a request to perform a debit transaction from the identified financial account for the cost of the financial transaction.

### CROSS-REFERENCES TO RELATED APPLICATIONS

This application is related to the following co-pending, commonly-assigned and concurrently filed U.S. patent applications, the entirety of each of which are herein incorporated by reference for all purposes: U.S. patent application Ser. No. ______, entitled “METHODS AND SYSTEMS FOR ONLINE TRANSACTION PROCESSING” (Attorney Docket No. 020375-050000); and U.S. patent application Ser. No. ______, entitled “METHODS AND SYSTEMS FOR UNIVERSAL TRANSACTION PROCESSING” (Attorney Docket No. 040143-050300).

### BACKGROUND OF THE INVENTION

This application relates generally to merchant transaction processing. More specifically, this application relates to methods and systems that allow debit transactions to be performed as part of private label transaction processing.

Consumers may pay merchants for purchases using a variety of payment types. Typically, these payment types include cash, checks, credit cards, and debit cards. Some merchants may also offer the consumer the option to pay with a private label card that may only be used to pay the merchant or merchants in the merchant consortium that issued the card.

Private label cards are typically credit-based cards. Consumers agree to pay merchants for purchases made using the private label cards according to the terms of their agreement. At the time of the purchase, a verification is performed that the consumer has not exceeded his or her available credit and the status of the account is acceptable. The consumer is then subsequently billed for all purchases made using the private label card.

While the use of such a credit-based system is appropriate for a number of circumstances, it also suffers from certain disadvantages. One disadvantage in particular is that credit transactions are generally not guaranteed. That is, a merchant who accepts a credit card for payment takes a risk that the payment will never be received because the cardholder disputes the legitimacy of the transaction. This may happen, for example, in a number of different fraud circumstances, with the non-guaranteed nature of the credit transaction resulting in the merchant being the victim of the fraud. The merchant also takes the risk that the consumer may default on their agreement to pay. This is in contrast to debit-based transactions, which generally are guaranteed to the merchant because specific funds identified in an account are designated at the time of the transaction as being allocated to the transaction.

### BRIEF SUMMARY OF THE INVENTION

Methods and systems are disclosed for private label transaction processing. In one embodiment, a method is disclosed that comprises receiving, at a payment network, a first information packet from a merchant. The first information packet includes a cost of a financial transaction between the merchant and a customer. The first information packet also includes a private label card account identifier presented by the customer as payment for the financial transaction. The private label card is a form of payment accepted only by either the merchant or members of a merchant consortium which includes the merchant. The payment network uses the private label card account identifier to determine account information that identifies a financial account maintained by the customer at a financial institution and authorization information that allows debit access to the identified financial account. The payment network then generates a second information packet comprising the transaction information, the account information, and the authorization information. The second information packet is then transmitted from the payment network to the financial institution with a request to perform a debit transaction from the identified financial account for the cost of the financial transaction.

In some embodiments, the method may additionally comprise receiving a response from the financial institution at the payment network. The response indicates approval or denial of the debit transaction. The payment network then transmit an authorization code to the merchant indicating approval or denial of the financial transaction in accordance with the response received from the financial institution. The payment network may also perform a risk analysis of the financial transaction and determine whether to provide a guarantee of the transaction to the merchant based on the risk analysis. The authorization code could also reflect whether the guarantee is provided.

Transmission of the second information packet to the financial institution may be accomplished in different ways. In one embodiment, the second information packet may be transmitted to the financial institution over an automated clearing house (“ACH”) network. In another embodiment, the second information packet may be transmitted to the financial institution over a debit system. In a third embodiment, the second information packet may be transmitted directly to the financial institution.

The information comprised by the first information packet may vary according to the embodiment. For instance, in one embodiment, the first information packet may further include a credential received from the customer. In this embodiment, the method may further comprise determining, with the payment network, that the credential is associated with the private label card account identifier.

Additionally, the information comprised by the second information packet may also vary according to the embodiment. By way of example, in one embodiment, the account information may comprise a primary account number (“PAN”) for the identified financial account and the authorization information may comprise a personal identification number (“PIN”) assigned to the customer for accessing the identified financial account.

In a second embodiment, a method is disclosed which comprises receiving, from a merchant, account information that identifies a financial account maintained by a customer at a financial institution and authorization information that allows debit access to the identified financial account. The payment network determines the account information and authorization information are authentic. A card number for a private label card is associated to the customer account information and authorization information. The private label card is a form of payment accepted only by the merchant or a merchant consortium that includes the merchant. The payment network transmits an enrollment approval for the customer to the merchant.

Associating the card number to the customer account information and authorization information may be done differently in different embodiments. By way of example, in one embodiment, a stock card number for a stock card may be received from the merchant before associating the card number. The stock card number received from the merchant may be associated to the customer account information and the authorization information. The method may additionally include validating, with the payment network, the stock card number is registered to the merchant before the performing the association. The method may also additionally include verifying, with the payment network, the stock card number has not been previously associated with a different customer account number before performing the association. In another embodiment, an account identifier for a private label card previously issued to the customer may be received from the merchant and may be used for the association. In other embodiments, a unique card number for the private label card may be generated with the payment network.

The account information may be received from the merchant in a variety of ways. For instance, in one embodiment, account information may be received from a merchant by receiving information read, using a magnetic stripe reader, from an instrument presented by the customer. In another embodiment, receiving account information may comprise receiving information read, using a MICR (Magnetic Information Character Recognition) reader, from a MICR line of a check presented by the customer.

The methods may be embodied in a payment network having a communications device, a processor, a storage device, and a memory coupled with the processor. The memory comprises a computer-readable medium having a computer-readable program embodied therein for directing operation of the payment network. The computer-readable program includes instructions for operating the computer system to manage information in accordance with the embodiments described above.

### BRIEF DESCRIPTION OF THE DRAWINGS

Illustrative embodiments in accordance with the invention are illustrated in the drawings in which:

FIG. 1 is a block diagram of a system that may be used for private label transaction processing;

FIG. 2 is a block diagram illustrating a payment network that may be used in the system of FIG. 1;

FIG. 3 is a block diagram of a computer system on which methods of the invention may be embodied;

FIG. 4 is a flow diagram illustrating an exemplary method for enrolling a customer into the payment network; and

FIG. 5 is a flow diagram illustrating an exemplary method for performing private label transaction processing.

### DETAILED DESCRIPTION OF THE INVENTION

In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

Methods and systems are provided for private label transaction processing. The private label transactions may involve the purchase of goods and/or services using a private label card. A private label card is a card issued by or on behalf of a merchant or merchant consortium. It may only be used to pay for items purchased from the merchant or members of the merchant consortium that issued the card or on whose behalf the card was issued. The members of a merchant consortium have commonly agreed to issue the private label card, thus, the private label card is not a generally accepted card (such as an association card).

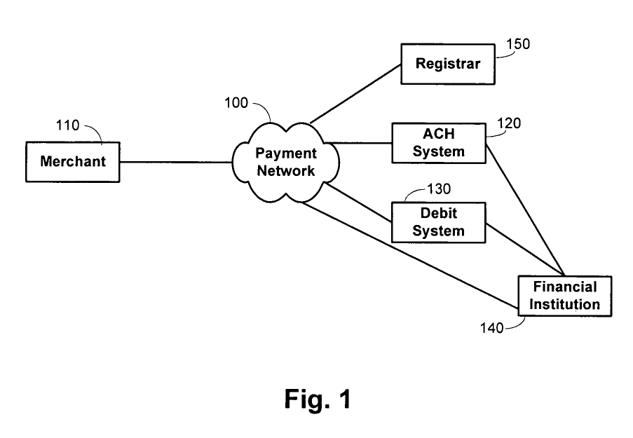

An overview of one system that may be used to support private label transactions is illustrated in FIG. 1. The system includes a payment network 100, which may be interfaced to different types of systems that may be used in supporting debit transactions. For example, one such system is the automated clearing house (“ACH”) system 120, which is an electronic payment-delivery system known to those of skill in the art. The ACH system comprises a network that provides batch-oriented electronic funds transfer governed by the NACHA operating rules. Briefly, the ACH network provides ACH operators that act as an interface between originating and receiving depository financial institutions. Transactions received at a financial institution 140 during a day may be stored and processed later in batch mode to exploit economies of scale. Debit transactions may also be supported by a debit system 130, sometimes referred to in the art as a network that comprises “debit rails” for effecting communications between financial institutions 140 to execute debit transactions from demand deposit accounts (“DDAs”). The interconnection provided by such debit rails of the debit system 130 allow real-time access to a customer's DDA information, including account balance, so that real-time debits of the DDA may be made. For example, such debit rails may be provided by known networks such as the NYCE® network, the Pulse® network, the STAR® network, and the like. In still other instances, an intermediary system like the ACH system 120 or debit system 130 may be avoided by using a direct connection to a financial institution 140, providing so-called “direct-to-bank” interactions.

The payment network 100 may be directly connected to merchant 110 so that transaction information entered into between merchant 110 and customers may be communicated to the payment network 100 to support the transaction. By way of example, point-of-sale devices (not shown) at the merchant location may be communicatively coupled to the payment network 100. A point-of-sale device which may be used by the merchant is described in application Ser. No. 10/116,689, entitled “Systems and Methods for Performing Transactions at a Point-of-Sale”, filed Apr. 3, 2002, the entire disclosure which is herein incorporated by reference. In alternate embodiments, merchant 110 may connect to the payment network 100 through the Internet or other communication means. It should be appreciated that more than one merchant 110 location may be communicatively coupled to the payment network 100. Additionally, in embodiments in which the payment network 100 is for private label transactions for a merchant consortium, additional merchants 110 that participate in the consortium may also access the payment network 100.

The security of information communicated between the payment network 100 and merchant 110 is generally greater with a direct connection. This is reflected by the illustration of FIG. 1 in which the payment network 100 is provided with interconnections to the ACH system 120, debit system 130, and direct links to financial institutions 140. As will be described in further detail below, the most sensitive financial information during transactions is communicated on this side of the system.

Parties may register with the payment network 100 using a registrar 150. Registrar 150 may be a separate entity as shown in FIG. 1, but more usually is merchant 110. In some embodiments, customers may be able directly register with the payment network 100.

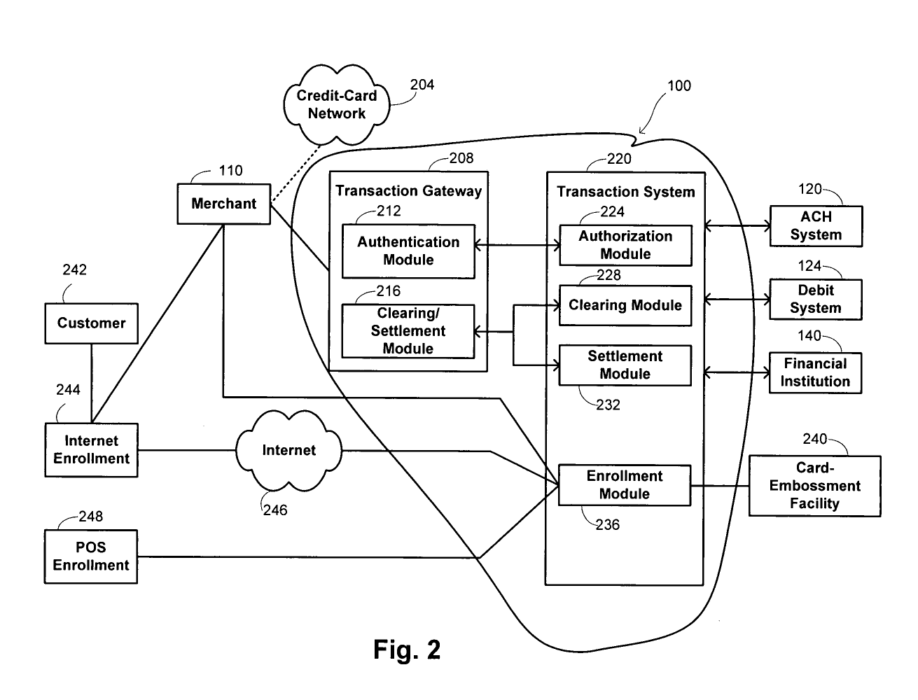

Details of the payment network 100 may be understood more fully with reference to FIG. 2, which shows an exemplary embodiment of the payment network 100. The payment network 100 may comprise a transaction gateway 208 and a transaction system 220, both of which may comprise a plurality of modules used in supporting transactions. The transaction gateway 208 may include an authentication module 212 that authenticates information provided by a merchant 110 during a transaction. The authentication module 212 interacts with an authorization module 224 of the transaction system 220 to coordinate seeking an authorization for the transaction. In addition, the transaction gateway 208 may further include a clearing/settlement module 216 that interacts with a clearing module 228 and a settlement module 232 of the transaction system 220 to perform clearing and settlement functions.

The transaction system 236 may also include an enrollment module 236 to accommodate different methods of enrollment. By way of example, merchant 110 may enroll customers using a point-of-sale enrollment 248 or other direct interface to enrollment module 236. Alternately, merchant 110 may enroll customers through an Internet enrollment 244 that connects to enrollment module 236 via the Internet 246. In some embodiments, the customer 242 may also be able to enroll an eligible private label card using internet enrollment 244. In one embodiment, the enrollment module may also be in communication with a card-embossment facility 240 to accommodate those embodiments in which enrollment of a customer may be coupled with preparation of a magnetic-stripe or other type of card.

The structure shown in FIG. 2 emphasizes certain aspects of the arrangement that illustrate its flexibility and integration into existing financial infrastructures. For instance, in any given transaction between a merchant 110 and a customer, the customer may still have the option of executing the transaction with different mechanisms. Thus, while the solid line between the merchant 110 and the transaction gateway 208 indicates paths that may be followed if the customer elects to perform a debit transaction using a private label card, the dashed line indicates a pathway to a credit-card network 204 that may be used if the customer elects to perform a credit transaction either with the same private label card or a different card. The infrastructure illustrated in FIG. 2 may thus be integrated with existing infrastructures without compromising the performance of such existing infrastructures. The interconnection of the payment network 100 with existing ACH systems 120, debit systems 130, or financial institutions 140 is coordinated with the transaction system 220 in the illustrated embodiment, but may be coordinated by the transaction gateway 208 in certain other embodiments.

It should be appreciated that alternate embodiments of payment network 100 may not include all the components illustrated in FIG. 2 or may include different components. For instance, the functionality provided by transaction gateway 208 and transaction system 220 may be combined into one component. As another example, the modules of transaction gateway 208 and/or transaction system 220 may be combined or may be further separated into additional modules.

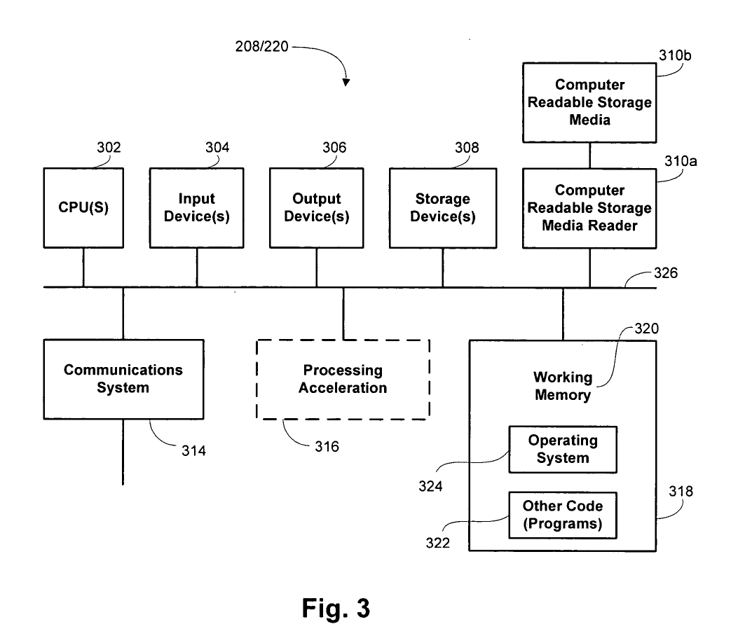

While FIG. 2 illustrates a logical structure for the payment system 100, FIG. 3 provides a schematic illustration of a physical structure that may be used to implement the transaction gateway 208 and/or transaction system 220 in one embodiment. FIG. 3 broadly illustrates how individual system elements may be implemented in a separated or more integrated manner. The structure 208/220 is shown comprised of hardware elements that are electrically coupled via bus 326, including a processor 302, an input device 304, an output device 306, a storage device 308, a computer-readable storage media reader 310a, a communications system 314, a processing acceleration unit 316 such as a DSP or special-purpose processor, and a memory 318. The computer-readable storage media reader 310a is further connected to a computer-readable storage medium 310b, the combination comprehensively representing remote, local, fixed, and/or removable storage devices plus storage media for temporarily and/or more permanently containing computer-readable information. The communications system 314 may comprise a wired, wireless, modem, and/or other type of interfacing connection and permits data to be exchanged with the merchants 110, between the transaction gateway 208 and transaction system 220, with the ACH system 120, with the debit system 130, with the financial institutions 140, with the card-embossment facility 240, or with any other external system as may be desired in implementing embodiments as described below.

The structure 208/220 also comprises software elements, shown as being currently located within working memory 320, including an operating system 324 and other code 322, such as a program designed to implement methods of the invention. It will be apparent to those skilled in the art that substantial variations may be made in accordance with specific requirements. For example, customized hardware might also be used and/or particular elements might be implemented in hardware, software (including portable software, such as applets), or both. Further, connection to other computing devices such as network input/output devices may be employed.

The architecture described above may be used in a variety of embodiments to implement debit-based transactions. Use of the architecture may include enrollment functions, in which customers are assigned a private label card account identifier and/or credentials that may be used as a mechanism for identifying the customer and the account to be used in the private label card debit transactions. The private label card account identifier may be embossed on a magnetic-stripe card. The customer may additionally be assigned additional identifying credentials, such as a personal identification number (“PIN”). For security, the PIN may be assigned to the customer separately. Other credentials are also envisioned. Once the customer has been assigned a private label card account identifier and has enrolled in the payment network 100, he or she may engage in debit-based transactions using the private label card. As executed transactions accumulate, there may be periodic clearing and settlement functions performed to reconcile the transactions.

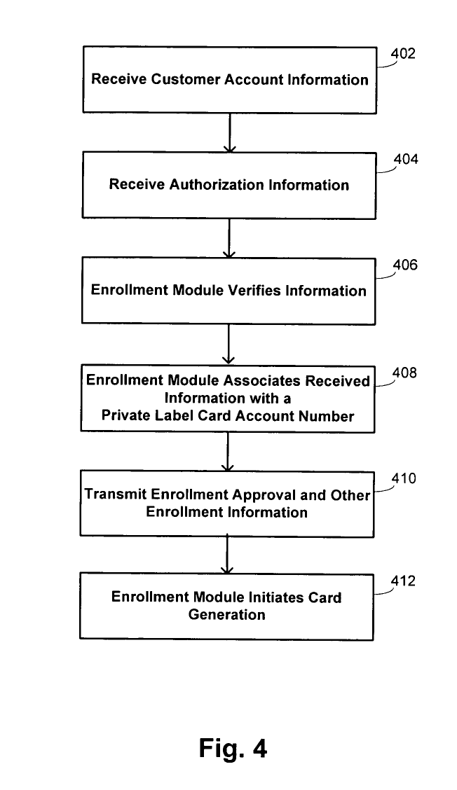

FIG. 4 is a flow diagram that illustrates an exemplary embodiment for enrolling a customer into the payment network 100. Enrollment module 236 receives 402 information identifying one or more customer accounts, such as demand deposit accounts (“DDAs”) from which funds are to be debited when the customer uses the private label card enrolled in the payment network 100. Such identification is typically made by the customer providing the primary account number (“PAN”) for the identified financial account(s) along with suitable financial-network routing information. The enrollment module 236 also receives 404 authorization information that allows debit access to the identified financial account(s). For example, the authorization information may comprise a personal identification number (“PIN”) assigned to the customer for accessing the identified financial account. In instances where more than one account is identified, a profile may be received or setup by the enrollment module 236 to identify allocations of debit transactions among the multiple accounts or specific identifications may be made at the time of a transaction.

The customer account information and authorization information may be provided to enrollment module 236 in a variety of different ways. In one embodiment, the information may be provided by a merchant 110 entering the information into a direct interface to enrollment module 236 or using an internet enrollment 244 interface. In another embodiment, the information may be received 402 via a point-of-sale enrollment interface 248. Information received 402 from a point-of-sale enrollment may take advantage of functionality that may be provided by a point-of-sale device. For instance, at least a portion of the account information may be read from an instrument (e.g., an embossed magnetic stripe card that may have been issued by the financial institution 140) presented by the customer using a magnetic stripe reader. Alternately, customer account information may be read from a MICR line of a check presented by the customer using a MICR reader.

Once the enrollment module 236 has collected the identification information, a verification 406 may be performed. Such verification may involve communications with the financial institution that maintains the identified account(s) to confirm the authenticity of the account information and authorization information (existence of the account, its ownership by the customer, correct authorization information, etc.). In some instances, the verification at block 406 may additionally include a risk-analysis based on such factors as the balance maintained in the identified account, credit score of the customer, demographic information regarding the customer, and the like. Approval of the customer to participate with the payment network 100 may depend in such instances not only on verification of the account status, but also on the customer having a satisfactory risk level.

If the customer information is accepted, the enrollment module 236 associates the customer account information and the authorization information to an account identifier for a private label card. The account identifier for the private label card may have been received from the merchant. For instance, the account identifier may be a stock card number for a stock card previously issued to the merchant 110. In that case, the enrollment module 236 may validate the stock card number is registered to the merchant 110 and/or the stock card number has not been previously associated with a different customer. As another example, the account identifier may be a number for a private label card previously issued to the customer which is now to be enrolled in the payment network 100. Alternately, a unique account identifier may be generated by enrollment module 236.

Enrollment module 236 may also associate additional credentials with the account identifier. By way of example, the enrollment module may assign (or the customer may select) a PIN to be used with the account identifier. This may provide added security for the private label card.

The association of the private label card account identifier (and in some embodiments additional credentials) with the account(s) specified by the user allows the payment network 100 to convert the private label card account identifier to a form of information suitable for performing a debit transaction when the private label account is used to pay for later financial transactions between the customer and the merchant 110. For example, the private label card account identifier may be used to determine the PAN/PIN combination used to ride the debit rails 130 or may be used to generate information suitable for an ACH transaction or a direct-to-bank transaction. The mapping between credentials and conventional debit-transaction identification information is maintained securely by the transaction gateway 208. Since this conventional information is not transmitted during transaction processing, there is little risk of it being compromised. In the event that the private label card assigned to the customer is stolen, a different private label account identifier may be substituted with new credentials by the transaction gateway 208 without needing to change account information at the financial institutions where the account(s) are held.

Assuming the enrollment process was completed successfully, an enrollment approval may then be transmitted 410 to the merchant or customer requesting enrollment. Additional information may also be transmitted to the merchant or customer, such as a newly assigned private label account identifier and/or credentials assigned to the customer. Some information may alternately or additionally be sent to the customer at a later time. For instance, a letter with a PIN number assigned to the customer may be mailed separately. If a new card is to be issued, the enrollment module 236 may also initiate 412 a request to a card embossment facility 240 to generate a new card.

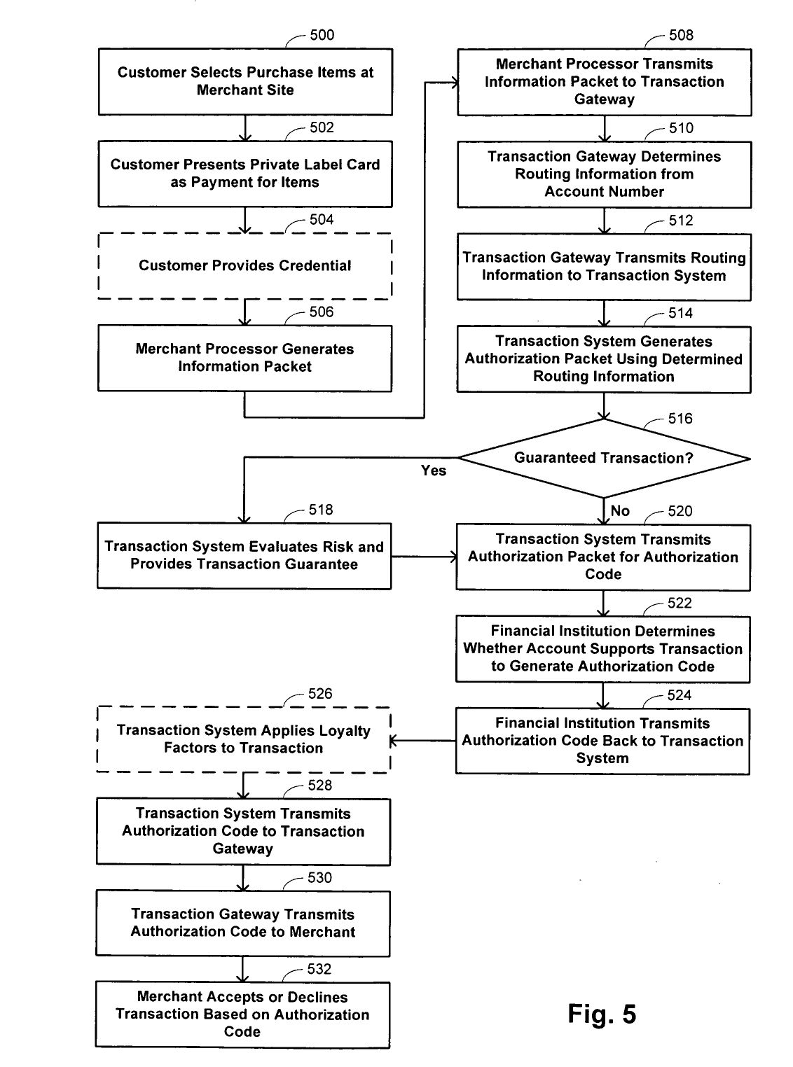

FIG. 5 is a flow diagram that provides an overview of methods used to execute a private label card transaction using the payment system 100 described above. A financial transaction between a merchant and a customer may be initiated by a customer selecting 500 a variety of purchase items at the merchant site. It should be appreciated that the merchant site may be a virtual site, such as an Internet site, provided by the merchant. After selecting the items, the customer then presents 502 a private label card as payment for the items. In some embodiments, the private label card may be used as both a traditional credit-based card and a debit-based card that uses payment network 100. In these embodiments, the customer may indicate at checkout how the card is to be used.

Optionally, the customer may then provide 504 a credential associated with the private label card. By way of example, the credential may be a PIN associated with the card. The customer may enter the PIN into a POS device or otherwise provide the PIN to the merchant. In alternate embodiments, the customer may not provide 504 a credential as there may not be a credential associated with the private label card.

When the merchant has access both to details of the transaction, such as the private label card account identifier and in some embodiments, the credentials provided 504, the merchant generates 506 an information packet. By way of example, this information packet may be generated by a POS device located at the merchant site, a computer system hosting a merchant Internet site, or other type of merchant processor. The information packet usually includes at least a specification of the amount of the transaction, an identification of the merchant, the private label card account identifier and in some instances the credential associated with the private label card account identifier. The information packet may also include additional information.

The information packet is then transmitted 508 from the merchant to the transaction gateway 208, which then uses the private label card account identifier comprised by the information packet to determine 510 routing information for the account. This routing information is transmitted 512 to the transaction system 220 with the other information from the information packet like merchant identification and transaction amount. This information is used by the authorization module 224 of the transaction system to generate 514 an authorization packet.

In some embodiments, the merchant may have the option of having the transaction guaranteed by the payment network 100. There are a number of different arrangements by which requests for guaranteed transactions may be initiated. For example, in some embodiments, all authorizations may be treated as guaranteed or all authorizations may be treated as non-guaranteed. In other embodiments, a merchant processor may pass an indicator with the information packet that specifies on a transaction-by-transaction basis whether the transaction is to be treated as guaranteed or non-guaranteed. In still other embodiments, rules may be established for implementation by the authorization module to define when to treat transactions as guaranteed or non-guaranteed. Such rules may account for such factors as the size of the transaction, the nature of the goods and/or services being sold, the identity of the customer, and the like.

A determination 516 is thus made in accordance with these different criteria whether a transaction is to be treated as a guaranteed transaction. If so, the transaction system 220 performs 518 a risk analysis of the transaction to determine whether to provide the guarantee. Such a risk analysis may take account of a variety of factors, such as the size of the transaction, the credit history of the customer, and the like, and may use standard techniques known to those of skill in the art in evaluating the risk. If the risk level associated with the transaction is acceptable, then the transaction is executed as a guaranteed transaction; if the risk level is determined to be unacceptably high, the transaction may be declined or an option may be fed back through the transaction gateway 208 to offer the merchant the possibility of treating the transaction as a non-guaranteed transaction. This provides a mechanism for overriding the predetermined factors defining when to treat a transaction as guaranteed, and offers the merchant an opportunity to determine whether to accept the transaction as a non-guaranteed transaction.

The transaction system seeks an authorization code for the transaction from the financial institution that holds the account to be debited. Seeking such an authorization code begins by transmitting 520 the authorization packet that was generated 514 to the financial institution 140. Such transmittal may take place through any suitable debit-transaction mechanism, including through the ACH system 120, through the debit system 130, or through a direct-to-bank connection to the financial institution 140 as described previously.

In some embodiments, logical rules may be set up to determine which transaction network to select. For instance, the transaction network may be selected based on a risk analysis of the financial transaction performed by the processor. Higher risk transactions may be processed on a transaction network with higher transaction costs but with little or no risk that funds will be available to cover the costs. Similarly, lower risk transactions may be processed on a transaction network with lower transaction costs but having a higher risk that funds may not be available to cover the costs. By way of example, higher risk transactions may use the debit system 130, while lower transactions may use the ACH system 120. Other criteria, such as whether the merchant requests a guarantee, may also be used to select the transaction network.

The financial institution 140 determines 522 whether the account identified by the authorization packet has sufficient cleared funds to support the transaction and transmits 524 an authorization code back to the transaction system 220 to reflect its determination. If the account has sufficient cleared funds and there are no other derogatory marks associated with the account, the authorization code comprises an approval of the transaction, while a failure to meet those conditions results in the authorization code comprising a denial of the transaction.

The transaction system 220 may, in some embodiments, be equipped to perform additional operations related to the transaction. Merely by way of example, FIG. 5 note that in some embodiments, loyalty factors may be applied 526 to the transaction. Such loyalty factors typically require monitoring an accumulated transaction amount associated with an individual customer, perhaps based on certain defined classifications of transactions, so that rewards may be provided to the customer when certain accumulation levels are met. Such rewards may take the form of points that may be redeemed to purchase items from the merchant, for air travel or other products, or may take the form of cash rewards that are deposited directly to the customers identified account, and the like. Still other types of operations additional to coordination of the debit transaction will be known to those of skill in the art and may be applied to transactions in other embodiments. In other embodiments, additional operations may not be performed.

The transaction system 220 transmits 528 the received authorization code to the transaction gateway 208, which transmits 530 it to the merchant 110. The merchant makes a determination 532 whether to accept or decline the transaction based on the authorization code, usually acting in strict accordance with the recommended acceptance or rejection of the transaction as determined by the financial institution 140.

In some embodiments, reporting capabilities may be provided to the customers. These reports may allow a customer to view previous transactions for the customer that were paid for using the private label card. Alternately or additionally, reports may also be provided to the merchant to allow the merchant to view merchant transactions that used payment network 100.

In the foregoing description, for the purposes of illustration, methods were described in a particular order. It should be appreciated that in alternate embodiments, the methods may be performed in a different order than that described. It should also be appreciated that various modifications, alternative constructions, and equivalents may be used without departing from the spirit of the invention. Accordingly, the above description should not be taken as limiting the scope of the invention, which is defined in the following claims.

1. A computerized method comprising:
receiving, at a payment network, a first information packet from a merchant, the first information packet including a cost of a financial transaction between the merchant and a customer and a private label card account identifier presented by the customer as a payment for the financial transaction, the private label card being a form of payment accepted only by one of the merchant and a merchant consortium that includes the merchant;
using the private label card account identifier to determine, with the payment network, account information that identifies a financial account maintained by the customer at a financial institution and authorization information that allows debit access to the identified financial account;
generating, at the payment network, a second information packet comprising the transaction information, the account information, and the authorization information; and
transmitting from the payment network, the second information packet to the financial institution with a request to perform a debit transaction from the identified financial account for the cost of the financial transaction.

2. The method of claim 1, further comprising:
receiving, at the payment network, a response from the financial institution indicating approval or denial of the debit transaction; and
transmitting, from the payment network, an authorization code to the merchant indicating approval or denial of the financial transaction in accordance with the response received from the financial institution.

3. The method of claim 2, further comprising:
performing, with the payment network, a risk analysis of the financial transaction; and
determining, with the payment network, whether to provide a guarantee of the financial transaction to the merchant based on the risk analysis,
wherein the authorization code further reflects whether the guarantee is provided.

4. The method of claim 1, wherein the first information packet further includes a credential received from the customer, the method further comprising determining, with the payment network, that the credential is associated with the private label card account identifier.

5. The method of claim 1, wherein:
the account information comprises a primary account number for the identified financial account; and
the authorization information comprises a personal identification number assigned to the customer for accessing the identified financial account.

6. The method of claim 1 wherein the second information packet is transmitted to the financial institution over an automated clearing house (“ACH”) network.

7. The method of claim 1 wherein the second information packet is transmitted to the financial institution over a debit system.

8. The method of claim 1 wherein the second information packet is transmitted directly to the financial institution from the payment network.

9. The method of claim 1 further comprising crediting, with the payment network, a loyalty program for the customer in response to execution of the financial transaction.

10. A computerized method comprising:
receiving, from a merchant, account information that identifies a financial account maintained by a customer at a financial institution and authorization information that allows debit access to the identified financial account;
verifying, with the payment network, the account information and authorization information;
associating an account identifier for a private label card to the customer account information and authorization information, the private label card being a form of payment issued on behalf of one of the merchant and a merchant consortium that includes the merchant;
transmitting, from the payment network, an enrollment approval for the customer to the merchant.

11. The method of claim 10, wherein verifying the account information and authorization information comprises:
transmitting, from the payment network, the account information and authorization information to the financial institution with a request to authenticate the information;
receiving, at the payment network, a response from the financial institution authenticating the information.

12. The method of claim 10, further comprising:
before associating the account identifier, receiving, from the merchant, a stock card number; and
wherein associating the account identifier comprises using the stock card number for the account identifier.

13. The method of claim 12, further comprising, before associating the stock card number, validating, with the payment network, that the stock card number is registered to the merchant.

14. The method of claim 12, further comprising before associating the stock card number, verifying, with the payment network, the stock card number has not been previously associated with a different customer account identifier.

15. The method of claim 10, further comprising:
before associating the card number, receiving, from the merchant, a customer private label account identifier for a private label card previously issued to the customer; and
wherein associating the card number comprising using the customer private label account identifier for the account identifier.

16. The method of claim 10, wherein associating the card number comprises generating, with the payment network, a unique card number for the private label card.

17. The method of claim 10, wherein receiving account information from the merchant comprises receiving information read, using a magnetic stripe reader, from an instrument presented by the customer.

18. The method of claim 10, wherein receiving account information from the merchant comprises receiving information read, using a MICR reader, from a MICR line, of a check presented by the customer

19. A payment network comprising:
a communications device;
a processor;
a storage device; and
a memory coupled with the processor, the memory comprising a computer-readable medium having a computer-readable program embodied therein for directing operation of the payment network, the computer-readable program including:
instructions for receiving, with the communications device, a first information packet from a merchant, the first information packet including a cost of a financial transaction between the merchant and a customer and a private label card account identifier presented by the customer as a payment for the financial transaction, the private label card being a form of payment accepted only by one of the merchant or and a merchant consortium that includes the merchant;
instructions for determining from the private label card account identifier, with the processor, account information that identifies a financial account maintained by the customer at a financial institution and authorization information that allows debit access to the identified financial account;
instructions for generating, with the processor, a second information packet comprising the transaction information, the account information, and the authorization information; and
instructions for transmitting, with the communications device, the second information packet to the financial institution with a request to perform a debit transaction from the identified financial account for the cost of the financial transaction.

20. The payment network of claim 19 wherein the computer-readable program further includes:
instructions for receiving, with the communications device, a response from the financial institution indicating approval or denial of the debit transaction; and
instructions for transmitting, with the communications device, an authorization code to the merchant indicating approval or denial of the financial transaction in accordance with the response received from the financial institution.

21. The payment network of claim 20 wherein the computer-readable program further includes:
instructions for performing, with the processor, a risk analysis of the financial transaction; and
instructions for determining, with the processor, whether to provide a guarantee of the financial transaction to the merchant based on the risk analysis,
wherein the authorization code further reflects whether the guarantee is provided.

22. The payment network of claim 19 wherein:
the communications system is coupled with an automated clearing house (“ACH”) network; and
the instructions for transmitting the second information packet to the financial institution comprise instructions for transmitting the second information packet over the ACH network.

23. The payment network of claim 19 wherein the instructions for transmitting the second information packet to the financial institution comprise instructions for transmitting the second information packet over a debit system.

24. The payment network of claim 19 wherein the instructions for transmitting the second information packet comprise instructions for transmitting the second information packet directly to the financial institution from the communications device.

25. The payment network of claim 19 wherein:
the account information comprises a primary account number (“PAN”) for the identified financial account; and
the authorization information comprises a personal identification number (“PIN”) assigned to the customer for accessing the identified financial account.

26. The payment network of claim 19 wherein the computer-readable program further comprises instructions for crediting, with the processor, a loyalty program for the customer in response to execution of the financial transaction.

27. A payment network comprising:.
a communications device;
a processor;
a storage device; and
a memory coupled with the processor, the memory comprising a computer-readable medium having a computer-readable program embodied therein for directing operation of the payment network, the computer-readable program including:
instructions for receiving, from a merchant, account information that identifies a financial account maintained by a customer at a financial institution and authorization information that allows debit access to the identified financial account;
instructions for verifying, with the processor, the account information and authorization information; and
instructions for associating, with the processor, a card number for a private label card to the customer account information and authorization information, the private label card being a form of payment issued on behalf of one of the merchant and a merchant consortium that includes the merchant; and
instructions for transmitting to the merchant, with the communications device, an enrollment approval for the customer.

28. The payment network of claim 27, wherein the instructions for verifying the account information and authorization information comprise:
instructions for transmitting, with the communications device, account information and authorization information to the financial institution with a request to authenticate the information;
instructions for receiving, with the communications device, a response from the financial institution authenticating the information.

29. The payment network of claim 27, wherein the computer-readable program further comprises:
instructions for receiving from the merchant, with the communications device, a stock card number; and
wherein the instructions for associating the card number comprise instructions for using the stock card number for the account identifier.

30. The payment network of claim 29, wherein the computer-readable program further comprises instructions for validating, with the processor, the stock card number is registered to the merchant.

31. The payment network of claim 29, wherein the computer-readable program further comprises instructions for verifying, with the processor, the stock card number has not been previously associated with a different customer.

32. The payment network of claim 27, wherein the computer-readable program further comprises:
instructions for receiving from the merchant, with the communications device, a customer private label account identifier for a private label card previously issued to the customer; and
wherein the instructions for associating the card number comprise instructions for using the customer private label account identifier for the account identifier.

33. The payment network of claim 29, wherein the computer-readable program further includes instructions for generating, with the processor, a unique card number for the private label card.
